(19) United States
(12) Patent Application Publication
(10) Pub. No.: US 2015/0175081 A1
(43) Pub. Date: Jun. 25, 2015

(54) METHOD AND APPARATUS FOR SUPPORTING A PORTABLE MEDIA DEVICE

(71) Applicant: White Compass, LLC, Miami, FL (US)

(72) Inventor: Sofia Rodriguez, Miami, FL (US)

(21) Appl. No.: 14/576,928

(22) Filed: Dec. 19, 2014

Related U.S. Application Data
(60) Provisional application No. 61/919,015, filed on Dec. 20, 2013.

(51) Int. Cl. B60R 7/04; A45F 3/02

(52) U.S. Cl. CPC B60R 7/043; A45F 3/02

(57) ABSTRACT

A system that incorporates teachings of the subject disclosure may include, for example, a collapsible supporting member, which includes a frame a portable media device retainer attached to the frame multiple strap anchors attached to the frame and a strap redirector. The strap redirector is affixed relative to the frame and positioned between two strap anchors of the multiple strap anchors. The device also includes an elongated strap having two opposing ends that are attached to the multiple strap anchors. The strap redirector engages a portion of the elongated strap at a location between the two opposing ends to form a multiple loops between the strap redirector and the two opposing ends. The multiple loops allow the frame to be suspended from a separate mounting structure. Other embodiments are disclosed.

### CROSS-REFERENCE TO RELATED APPLICATION(S)

This application claims the benefit of U.S. Provisional Application No. 61/919,015, filed Dec. 20, 2013, which is incorporated herein by reference in its entirety.

### FIELD OF THE DISCLOSURE

The subject disclosure relates to a method and apparatus for supporting a portable media device.

### BACKGROUND

Portable media devices allow for presentation of various forms of media content, such as video, images, audio and text. Examples of portable media devices include tablet devices, personal digital assistants, smart phones and electronic readers. These portable devices provide controls, such as a touch screen display, that allow viewers to access and control presentation of media content thereon. Portable media devices have been widely embraced by the public, particularly with the rapid growth of wireless high-speed data access, such that users can access and consume media content in a variety of different locations, and particularly during periods of travel.

### BRIEF DESCRIPTION OF THE DRAWINGS

Reference will now be made to the accompanying drawings, which are not necessarily drawn to scale, and wherein:

FIGS. 1A-1C depict front, side and rear schematic views, respectively, of an illustrative embodiment of supporting structure for a portable media device;

FIG. 1D depicts a perspective view of the supporting structure of FIGS. 1A-1C rolled into a compacted configuration;

FIGS. 2A-2C depict views of an illustrative embodiment of the supporting structure of FIGS. 1A-1D in deployed configurations;

FIG. 3 depicts a front schematic view of another illustrative embodiment of a supporting structure for a portable media device;

FIGS. 4A-4B depict front and rear views of an illustrative embodiment of supporting structure for a portable media device;

FIG. 5 depicts an illustrative embodiment of the supporting structure of FIGS. 1A-1D mounted to a headrest portion of an airline seat;

FIG. 6 depicts an illustrative embodiment of a mounting strap assembly of the embodiment of the supporting structure shown in FIG. 5;

FIG. 7 depicts an illustrative embodiment of the supporting structure of FIGS. 1A-1D mounted to a tray table portion of an airline seat;

FIG. 8 depicts an illustrative embodiment of a mounting strap assembly of the embodiment of the supporting structure shown in FIG. 7;

FIGS. 9A-9B depict illustrative embodiments of the supporting structure of FIGS. 1A-1D mounted to headrest portions of an automobile seat;

FIG. 10A-10B depicts an illustrative embodiment of the supporting structure of FIGS. 1A-1D mounted to a suitcase; and

FIG. 11 depicts a process for securing a portable media device to another structure.

### DETAILED DESCRIPTION

The subject disclosure describes, among other things, illustrative embodiments of a process and a device for supporting a portable multimedia device in relation to a mounting strap that can be configured as a single loop or multi-loop configuration allowing the device to be removably secured to structures, such as an airplane seat back and/or tray table for hands-free viewing.

In some embodiments, the device can be configured between single loop and multi-loop mounting configurations to allow for mounting of the portable multimedia device to a greater of variety of mounting structures. Other embodiments are included in the subject disclosure.

One embodiment of the subject disclosure includes a device includes a frame to receive a portable media device having a display surface. The display surface of the portable media device, when received within the frame, is substantially unobstructed. The frame includes multiple strap anchors and a strap redirector positioned with respect to the plurality of strap anchors. The device also includes an elongated strap having two opposing ends that are attached to the multiple strap anchors. The strap redirector engages a portion of the elongated strap at a location between the two opposing ends to form a multiple loops between the strap redirector and the two opposing ends. The multiple loops allow the frame to be suspended from a separate mounting structure, such that the display surface is positioned to allow hands-free viewing of media content displayed upon the portable media device.

Another embodiment of the subject disclosure includes a device includes a collapsible supporting member, which includes a frame a portable media device retainer attached to the frame multiple strap anchors attached to the frame and a strap redirector. The strap redirector is affixed relative to the frame and positioned between two strap anchors of the multiple strap anchors. The device also includes an elongated strap having two opposing ends that are attached to the multiple strap anchors. The strap redirector engages a portion of the elongated strap at a location between the two opposing ends to form a multiple loops between the strap redirector and the two opposing ends. The multiple loops allow the frame to be suspended from a separate mounting structure.

Yet another One embodiment of the subject disclosure includes a process provides a frame to receive a portable media device having a display surface. The display surface of the portable media device, when received within the frame, is substantially unobstructed. The process also includes securing opposing ends of an elongated strap to the frame to obtain a first loop suitable for mounting the frame to structure. A mid-portion of the elongated strap is removably secured to the frame between the opposing ends. The elongated strap, when secured to the frame at the mid-portion, results in multiple second loops suitable for mounting the frame to the structure.

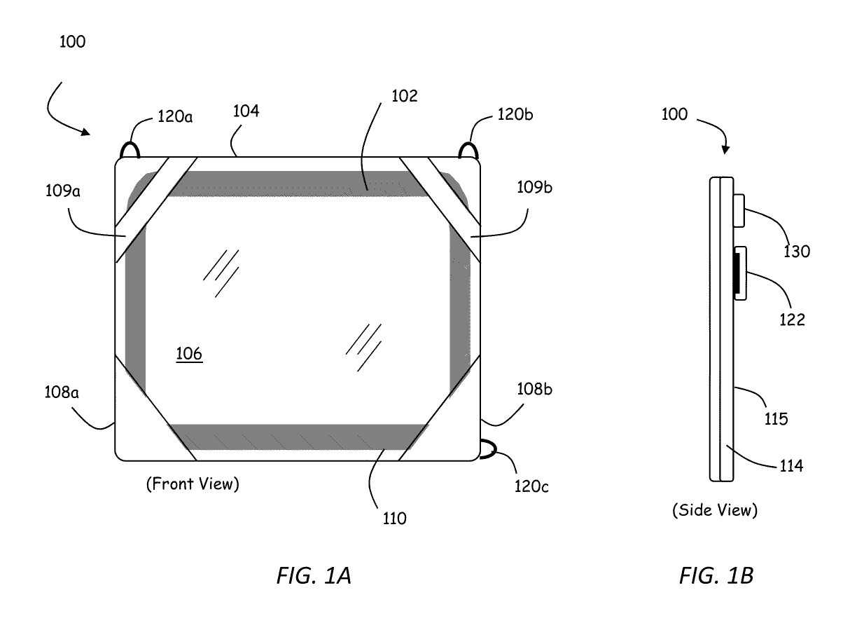

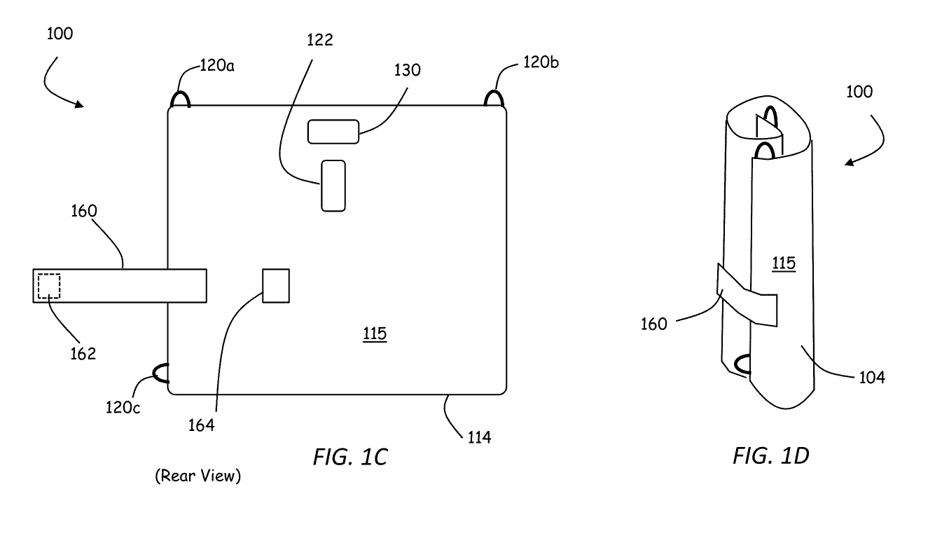

FIGS. 1A through 1C depict front, side and rear schematic views, respectively, of an illustrative embodiment of an assembly 100 for supporting a portable multimedia device 102 in relation to another structure to allow hands-free operation of the multimedia device 102 during presentation, e.g., viewing, of multimedia content. The assembly 100 includes a supporting member 104, such as a frame or sleeve, configured to receive the multimedia device 102. In the illustrative embodiment, the multimedia device has a display surface 106. The sleeve 104 is further configured to allow the display surface 106 to remain substantially unobstructed when the multimedia device 102 is received therein. In the illustrative embodiment, the sleeve 104 includes a back portion or backing that abuts a rear surface of the multimedia device 102 when supported thereon.

In this embodiment, pockets 108a, 108b (generally 108) are formed along one or more corners of the sleeve 104. Corner pockets 108 can be constructed or otherwise formed according to any of the techniques disclosed herein. In the illustrative example, three pockets are formed of non-elastomeric materials. A fourth corner of the sleeve includes an elastic material sized and positioned to engage a fourth corner of the table device when seated within the sleeve such that the other three corner pockets engage the other three corners of the tablet device.

The sleeve 104 can be fashioned from various materials. In some embodiments, the sleeve 104 is flexible, e.g., being manufactured from material such as leather, or other synthetic material having similar flexible properties with little or no elasticity. Flexible materials include, without limitation, leather, polymers, and fabrics, e.g., textiles. Fabrics can include woven and non-woven fabrics. Fabrics can be made from natural fibers, synthetic fibers or combinations of natural and synthetic fibers. Examples of natural fibers include, without limitation, cotton, e.g., canvas, linen, silk, wool. Likewise, synthetic fibers include, without limitation, polyester, olefin, acrylic, aramid, carbon, nylon, rayon. Fabrics can be durable, such as fabrics used in the construction of luggage and/or backpacks. In at least some embodiments, the fabrics can be treated, e.g., such as coated, with another material, such as a stain resistant coating, a waterproof coating, a dye and/or an ink, and so forth.

Alternatively or in addition, the sleeve 104 can be manufactured from a material having resilient or elastic properties. Elastic components can be sized intentionally smaller than the tablet device 102. Accordingly, such undersized elastic sleeves and/or sleeve components can be stretched to receive the tablet device 102. Upon receiving the tablet device 102, the stretched elastic sleeves 104 and/or sleeve components can be allowed to relax. Being intentionally undersized, the elastomeric sleeve/component(s) remain stretched to some degree, resulting in retaining forces acting on the tablet device 102 to support the tablet device 102 relative to the sleeve 104. Placement of the elastomeric sleeve/component(s) can be selected, such that the forces tend to retain the tablet device 102 within the assembly 100. Examples of elastic materials include, without limitation, elastomeric materials, unsaturated rubbers, saturated rubbers, and other polymers with viscoelasticity, generally having a low Young's modulus and a high failure strain compared with other, non-elastomeric materials. In some embodiments, resilient or elastic materials are incorporated into a fabric along or in combination with other fibers, e.g., non-elastomeric fibers. Weaves can be controlled to allow a composite fabric having elastic and non-elastic fibers to stretch, having overall elastomeric properties.

Alternatively or in addition, the sleeve 104 can be manufactured from one or more materials that are rigid semi-rigid, and/or compliant or floppy. Examples include metals and plastics. By way of non-limiting example, the backing can be made from a rigid material, such as a metal and or a molded plastic. Instead of or in addition to pockets, such rigid and/or semi-rigid materials, the sleeve 104 assembly can include one or more mounting brackets. Such mounting brackets can include flexible components dimensioned to a relatively tight tolerance to allow for a frictional engagement of the tablet device, e.g., by way of a frictional, e.g., “snap” fit. Rigid and/or semi-rigid materials can be segmented and/or jointed to allow the sleeve 104 to be collapsed or otherwise compacted for stowage. In some embodiments, one or more different materials can be used in combination. For example, rigid and/or semi-rigid materials, such as plastics and/or metals, can be attached to and/or secured to, e.g., within, a flexible, or compliant material, such as a fabric.

In some embodiments, more than one corner includes elastic retainers 109a, 109b (generally 109). For example, two, three or even all four corners can include elastic retainers 109, such as elastic straps or band. The elastic straps can be attached to a flexible backing 114 and/or a semi-rigid and/or a rigid backing as disclosed above. In the illustrative example, the backing 114 is flexible, such that the case 100 can be folder or otherwise rolled up during periods of non-use. In some embodiments, one or more of the retainers 108 can be rigid or semi-rigid. Flexure can be provided by one or more of the retainers 108 or the sleeve 104 to allow the device 102 to be securably engaged and removed from the support assembly 100.

In at least some embodiments, the portable media device 102 can be removably attached to the case 100. Referring to the case of FIG. 1A, a rear surface of the device 102 can be placed against an opposing surface of the case 100, such that the bottom edge 110 of the device 102 is above the open areas of the pockets 108. A downward motion of the device 102 relative to the case 100 causes two corners of the bottom edge 110 to be seated within the bottom brackets or pockets 108 of the case 100. The elastic retainers 109 can be pulled over the top corners of the device 102, such that the device 102 is retained within the case 100 at all four corners. Such secure mounting can provide support that prevents movement of the device 102 relative to the case 100 during periods of attachment. In order to detach the device 102 from the case 100, the process can be reversed. For example, corners of the device 102 can be removed from the elastic straps 109 and the device 102 slid upward and out of the two bottom corner pockets 108.

Referring to FIG. 1B, the assembly 100 can include one or more anchors 120a, 120b, 120c (generally 1120) to anchor or otherwise secure a mounting strap. In the illustrative embodiment, two anchors 120a, 120b are provided along a top edge of the sleeve 104. In particular, the two anchors 120a, 120b are positioned adjacent top corners of the backing 114. In some embodiments, a third anchor 120c is positioned along a side edge of the sleeve 104. The anchors 120 can be integrally formed with the backing 114, e.g., in an injection molded configuration. Alternatively or in addition, the anchors 120 can be attached to the backing 114 of the sleeve 104. By way of non-limiting example, each anchor 120 can include one or more of a loop, a hook, or some other fastener to engage a corresponding end of the mounting strap (not shown). Loops can be formed from flexible material, such as fabrics, that are attached to the rear surface of the backing. Any suitable means of attachment can be used, such as stitching, chemical bonding, thermal bonding, mechanical fasteners, e.g., staples, rivets, screws, pins, and the like. Although the anchors 120 are shown positioned away from an outer edge of the backing 114, it is understood that the positioning is not limited to such positions. For example, in some embodiments, one or more of the anchors 120 can extend away from one or more of the outer edges of the backing 114, e.g., along an interior region of the backing 114. Although anchors 120 are disclosed herein, it is understood that anchors are not required, e.g., in instances in which a mounting strap (not shown) is integrally formed with one or more of the backing 114 or the sleeve 104.

As will be described in more detail below, a mounting strap can be coupled between the pair of anchors. The mounting strap can be configured with couplings at each end to engage the anchors. The couplings can be removable, e.g., using a mechanical fastener, such a hook and or a loop allowing one and/or both ends of the mounting strap to be removed or otherwise attached to the backing of the sleeve. Alternatively or in addition, the couplings can be fastened to the sleeve in non-releasable manner. Examples can include one or more ends of the mounting strap being fastened to the rear surface, e.g., by way of stitching, a staple, a chemical and/or thermal bond, and so forth.

The assembly 100 also includes at least one loop 122 through which the flexible mounting strap can be threaded. In the illustrative embodiment, the backing 114 includes one loop 122 positioned on a rear surface 115. The loop 122 can be a separate structure attached or otherwise fashioned to the backing 114, e.g., as in a belt loop attached to a garment. Any suitable means of attachment, such as any of those disclosed herein, can be used to attach the loop 122 to the backing 122. In some embodiments, both ends of a closed loop are attached to the rear surface 115, such that an unattached end of the flexible mounting strap can be routed through an opening of the loop 122. Alternatively or in addition, the loop 122 can include a fastener, such that the loop can be opened or closed. Accordingly, the flexible mounting strap can be routed through the loop without having to remove either end of the mounting strap from its corresponding anchor.

Although closed loops 122 are illustrated herein, it is also understood that open loops can be used. For example, a loop can be open along a bottom edge, essentially forming a hook structure closed along the top edge and open along the bottom and side edges. In operation, the flexible mounting strap can be slipped into a bottom opening of the hook. When mounted to another structure, gravity pulling down on the assembly will tend to force the flexible strap upwards, urging it against the closed edge of the hook structure.

Still other embodiments, include a loop formed by parallel openings or slits formed in or along the rear surface 115, e.g., allowing the flexible mounting strap to be thread down through one of the parallel openings and up through another of the parallel openings. That portion of the backing 114 disposed between the pair of parallel openings serves as the loop. It is also conceivable that the loop can be provided by a single aperture, e.g., as in a through opening of a portion of the backing extending above an upper edge of the tablet device. In this configuration, the flexible mounting strap can enter the hole from one of the front or rear surfaces of the backing 114 and exit along an opposite surface. It is also understood that although one loop 120 and/or hook is disclosed, it is possible to include more than one and/or a combination of one or more loops and one or more hooks. A mounting strap can be threaded through one or more of the multiple loops and/or hooks to accommodate a suitable fit to a mounting structure.

Alternatively or in addition, the structure 100 includes a hook and/or loop 130 adapted to engage a feature of another structure. The hook or loop 130 can be sized and positioned to allow the structure 100 to be supported from a protuberance, such as a hook, handle, knob, lever, dial, nail, fastener, or the like. The hook or loop 130 allows the structure 100 to be mounted without necessarily using the mounting strap 140, although it is envisioned that the strap 140 can be used in at least some embodiments in combination with the hook or loop 130. The strap 140 can include one or more of a cord, a ribbon, a wire, a rope, and the like. The strap 140 is generally conformable, e.g., to form one or more loops for mounting.

The strap 140 itself can be flexible, as in a ribbon that is easily conformed to different shapes. Alternatively or in addition, the strap 140 can have some rigidity, e.g., as in a wire. Thus, loops can be formed for hanging the device, without necessarily confirming to a contour of a structure upon which the strap 140 is hung.

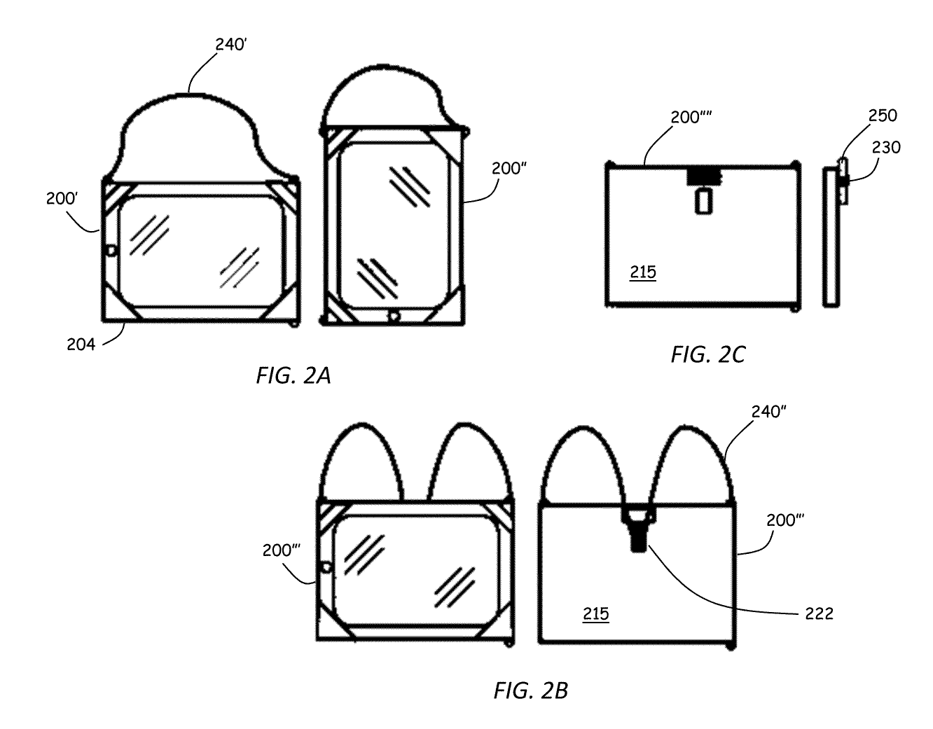

FIG. 2A illustrates a front view of the supporting structure 200′ in each of a landscape configuration 200′ and a portrait configuration 200″. In the landscape configuration 200′, a mounting strap extends in a single loop between the two anchors along a top edge of the sleeve 204. In the portrait configuration 200″, the mounting strap 240 extends in a single loop between the two anchors along a side edge of the sleeve 204.

FIG. 2B illustrates a front and rear view of the supporting structure 200′″ in a dual loop configuration. In this configuration, the structure 200′″ includes the mounting strap extending between the two anchors along the top edge of the sleeve 204, with the strap threaded through a central loop 222 located on the back surface 215.

FIG. 2C illustrates a rear and side view of the supporting structure 200′ in a simple loop configuration. In this configuration, the structure 200′ does not require the mounting strap 240, but instead relies upon the hook or loop 230 along the rear surface 215 for hanging upon a protuberance 250.

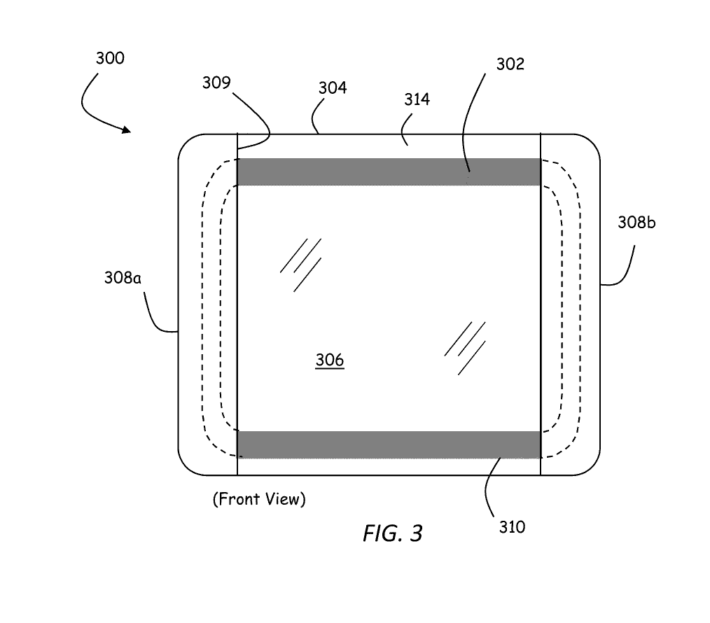

FIG. 3 depicts a front schematic view, of another illustrative embodiment of supporting structure 300 for a portable media device 302. One or more pockets are provided along one or more edges of the structure 300. For example, opposing pockets 308a, 308b (generally 308) are disposed along opposite edges of the structure 300. The pockets 308 include open ends 309 that face inward, e.g., facing the opposing pocket 308.

The structure 300 can include a backing 301 be dimensioned, e.g., having a length and a width corresponding to a form factor of a particular multimedia device 302 or class of multimedia devices. For example, the backing 314 can be dimensioned to correspond to small tablets, e.g., from about 7 to about 8.5 inches, to medium tablet devices, e.g., from about 8.5 to about 10 inches, and/or to large table devices, e.g., greater than about 10 inches. Example devices include the iPad® tablet, the Kindle® tablet, the Galazy® tablet and the Nook® tablet. Other devices can include, without limitation, electronic readers, smart phones, MP3 players, and the like. The backing 314 can be dimensioned slightly smaller than the multimedia device 302, approximately the same size as the multimedia device 302, or larger than the multimedia device 302. Regardless of the dimensions of the backing 314, each pocket 308 is dimensioned to accept an adjacent portion of the multimedia device 302.

In the illustrative example, the sleeve 304 is affixed to or otherwise integral to a backing 314 that is slightly larger than the multimedia, or tablet device 302. Opposing pockets 308 are provided at opposing ends spaced apart along a largest dimension of the tablet device 302. The opening 309 of each pocket 308 receives a portion of an adjacent edge of the tablet device 302. When received within the structure 200, the pair of opposing pockets 308 prevents the tablet device 302 from moving with respect to the structure assembly 300. In some embodiments, some movement is possible, while still maintaining the tablet device 302 substantially secured with respect to the assembly 300. It is understood that in at least some embodiments, one or more pockets 308 can be provided along one or more of the long edges 310 of the tablet device 302 along, and/or in combination with pockets (not shown) along the short edges of the tablet device 302.

In some embodiments, the support structure 300 includes one large pocket to accommodate, e.g., the entire tablet device 302. An outer surface of the pocket, i.e., a surface opposite the backing 314, can include an aperture sized and positioned to expose substantially an entire display surface 306 of the tablet device 302 when received within the pocket. Consider, by analogy, a large document envelope having an opining along one edge to receive documents and a large viewing window to allow inspection of documents contained within the envelope. The aperture can be open, covered or at least partially covered. A covering of the aperture can be transparent, translucent or otherwise configured to allow viewing of visual content presented on the display surface 306. In some embodiments, the covering can include optical properties, such as one or more of a tint, a filter, a lens, a coating, and the like.

FIG. 1D depicts a perspective view of the supporting structure assembly 100 of FIGS. 1A-1C rolled into a compacted configuration. In at least some embodiments, the assembly 100 includes a stowing feature, such as a binding strap 160, that can be used to retain the assembly 100 in a compacted or stowed configuration during periods of storage. As shown, an elongated binding strap 160 can be fastened at one end to a rear surface 115 of the sleeve 104. Another end of the binding strap 160 can include a first fastener 162 positioned and otherwise configured to engage a corresponding second fastener 164. For example, a second fastener 164 such as a loop portion of a hook and loop fastener can be attached to the rear surface 115 of the assembly 100. A hook portion of the hook and loop fastener 162 can be attached to a free end of the binding strap 160. When rolled into a compacted configuration, as shown, the free end of the binding strap 160 can substantially align with the loop portion 164 to allow for a hook and loop engagement. Similar binding features can be found on other devices, such as umbrellas. Other binding straps can include a string or laces for tying, an elastic member, and so on. Other fastening members can include snaps, buttons, and the like.

Although a rolled-up stowed configuration is illustrated, other stowed configurations are possible. For example, the structure 100 can be folded upon itself one or more times, combinations of folds and rolling, or simply crumpled or otherwise compacted. In some embodiments, the structure 100 includes a feature, such as the binding strap 160, a pocket, or strategically placed fasteners can be used to retain the structure in a compacted stowed configuration during periods of non use.

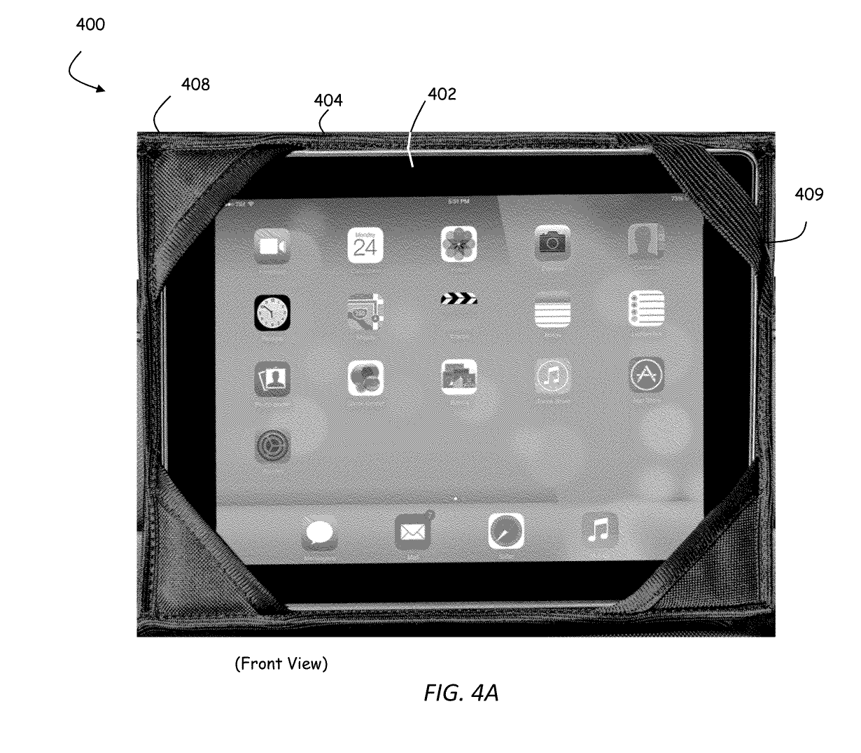

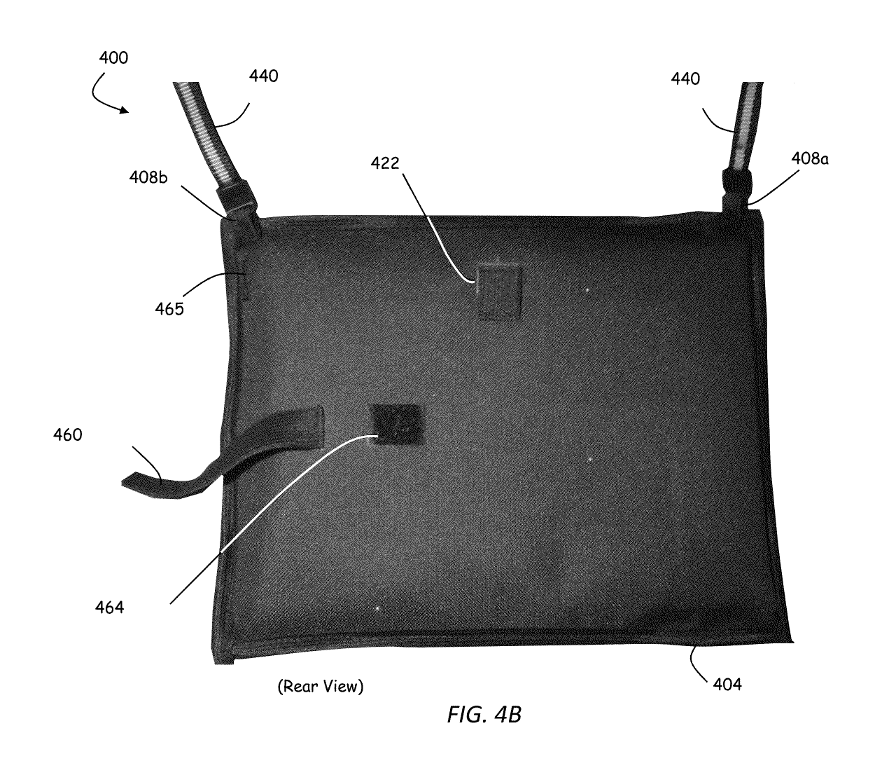

FIG. 4A depicts a front view of an illustrative embodiment of supporting case 400 for a portable media device 402. The case 400 includes a sleeve 404 formed from a durable synthetic fabric. The sleeve includes three pockets 408 at three of the four corners. An elastic retaining strap 409 is included at a fourth corner of the sleeve 404. Construction details are achieved using one or more of stitching and bonding.

FIG. 4B depicts a rear view of the illustrative embodiment of case shown in FIG. 4A. Visible from the rear view are a loop 422, a binding strap 460 and a fastener 464 for use in combination with the binding strap. Also shown is an access port 465. One or more such access ports can be strategically placed to allow access to one or more controls of the device 402, while the device is secured to the supporting structure 400. In the illustrative example, the access port is simply an opening in the material of the sleeve. In some embodiments, the opening can be similar to a button hole. Alternatively or in addition, a periphery of the access port 465 can include a supporting structure, such as a grommet, a ridge, and the like.

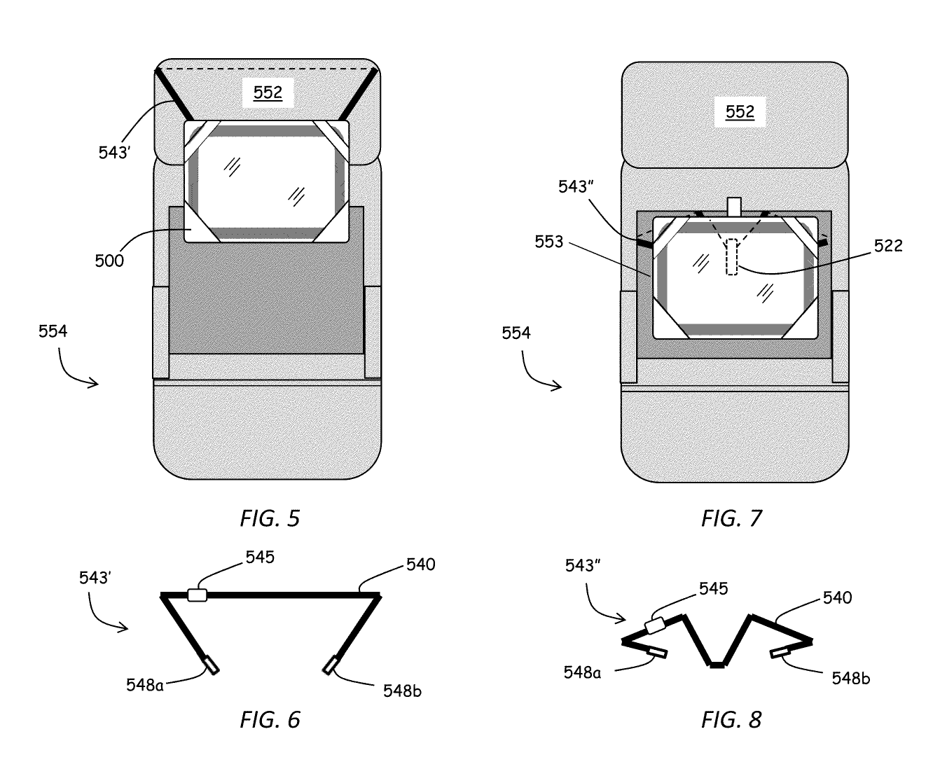

FIG. 5 depicts an illustrative embodiment of a supporting structure 500, similar to that shown in FIGS. 1A-1D, mounted to a headrest portion 552 of an airline seat 554. In the illustrative embodiment, a flexible mounting strap assembly 543′ is attached at either end to anchor points along a mounting sleeve of the supporting structure 500. A single open loop formed between an inner surface of the flexible mounting strap and the mounting sleeve can be draped or otherwise routed around a mounting structure, such as an airplane seat back 552, as shown. In particular, the single loop can be routed around a top, headrest portion 552 of the seat 554 so as not to disturb a passenger in the forward seat. When so mounted, the sleeve can be aligned in front of a person sitting in the seat immediately behind the forward seat to which the tablet 502 device has been mounted. It is understood that in at least some embodiments, a length of the flexible mounting strap assembly 543′ can be adjustable to allow for mounting to different structures, different sized seats, e.g., car seats, and/or to adjust a height/position of the display surface to allow for optimal hands-free viewing.

FIG. 6 depicts an illustrative embodiment of a strap assembly 543′. The strap assembly 543′ includes a mounting strap 540 having at least one elongated flexible portion attached to at least one anchor 548a. Another end of the flexible portion 540 can be attached to another anchor 548b to allow the strap assembly to be mounted to a pair of anchors of the supporting structure assembly 500. In some embodiments, the strap assembly 543′ includes an adjustable feature 545. The adjustable feature 545 can be used to adjust an overall length of the strap assembly 543′ between the two anchors of the supporting structure assembly 500.

The one or more elongated flexible portions 540 of the strap assembly 543′ can be made from any of the various materials disclosed herein. In some embodiments, the flexible portions of the strap 540 can be made from the same material as the sleeve assembly 104 (FIG. 1A-1D).

FIG. 7 depicts an illustrative embodiment of the strap assembly 543″ mounted to a tray table 553 portion of the airline seat 554. In particular, the strap assembly 534″ is configured in a multi-loop configuration, e.g., two loops, to engage opposing top corner portions of the tray table 553. In this configuration, the strap assembly 543″ can be attached at either end to the pair of anchors of the sleeve assembly as disclosed above. A mid portion of the elongated flexible portion 540 of the strap assembly 543″ can be threaded through an extra loop 522 of the supporting structure 500 to form two or more mounting strap loops for mounting to corners of the tray table 553. As illustrated, the case 500 can be mounted to the tray table 553 in its stowed position using the multi-loop configuration 543″. In particular, the multi-loop mounting allows a viewing height of the device 502 to be positioned higher than would otherwise result from the device 502 being placed on the tray table in its deployed position, i.e., tray table 553 down in a food/beverage serving position. In at least some embodiments, the viewing height can be controlled according to one or more of adjusting a length of the adjustable strap 540 and adjusting the number of loops. For example, a three or four loop configuration can be used to raise the viewing height of the device with respect to a one or two loop configuration.

FIG. 8 depicts an illustrative embodiment of the mounting strap assembly 543″ of the embodiment of the case shown in FIG. 7. The mounting strap assembly 543″ includes at least one elongated flexible portion 540 attached to at least one anchor 548a. Another end of the flexible portion 540 can be attached to another anchor 548b to allow the strap assembly 543″ to be mounted to the pair of anchors of the sleeve assembly of the supporting structure 500. The strap 540 is routed through the one or more additional loops 522 and/or hooks to form at least two loops extending away from the mounting sleeve of the supporting structure 500. As illustrated, two such loops can be used to engage a mounting structure, such as opposing corners of an airplane tray table 553. Once again, the length and/or configuration of the strap assembly 543″ can be adjusted to cause the mounting sleeve 500 to be suspended from the separate mounting structure 553 at an optimal position/height for hands-free viewing.

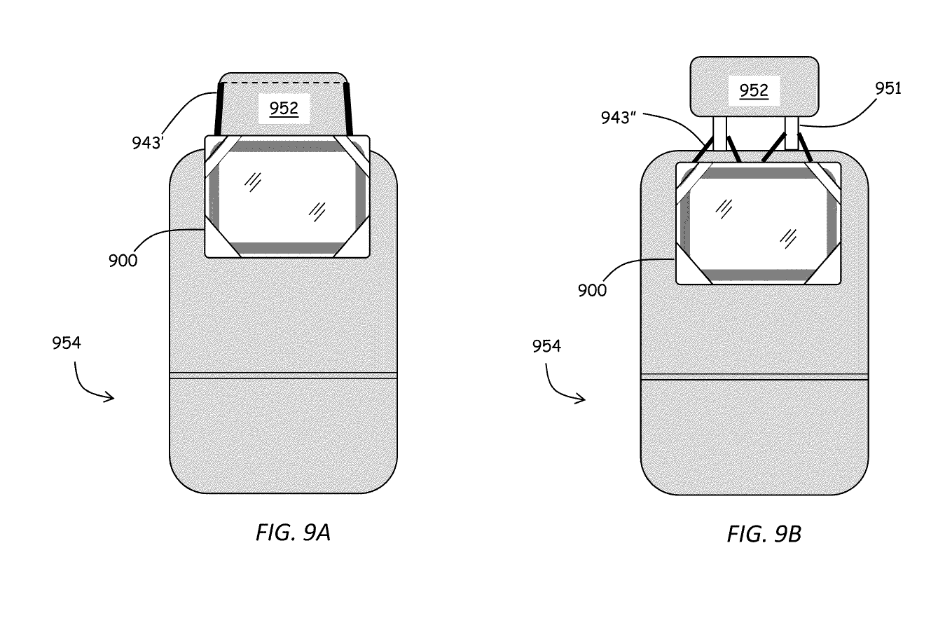

FIG. 9A depicts an illustrative embodiment of a supporting structure 900 mounted to a headrest portion 952 of an automobile seat 954 according to a single loop configuration 943′. FIG. 9B depicts an illustrative embodiment of the supporting structure 900 mounted to the headrest portion 952 of the automobile seat 954 according to a double loop configuration 943″.

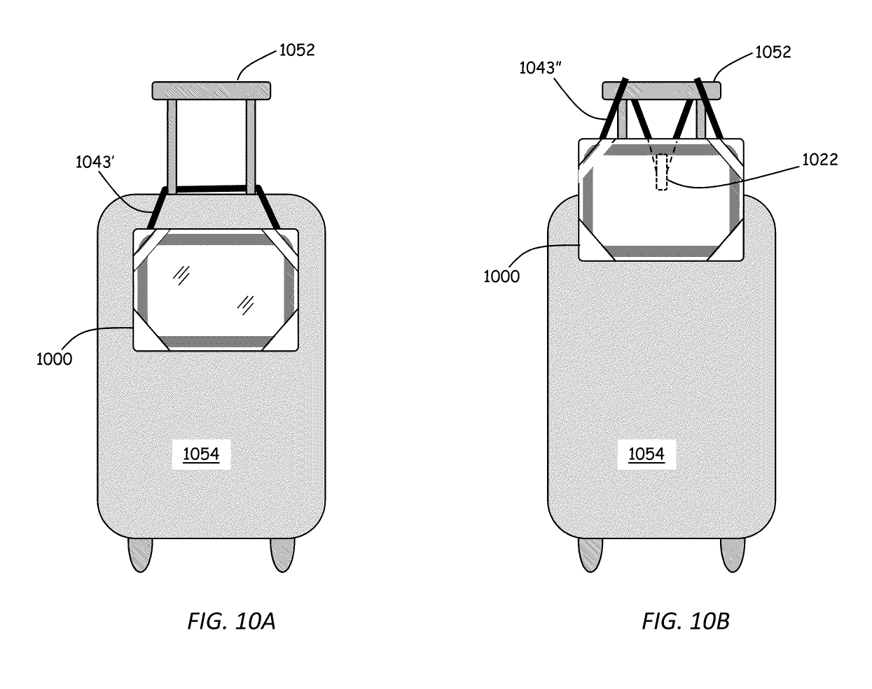

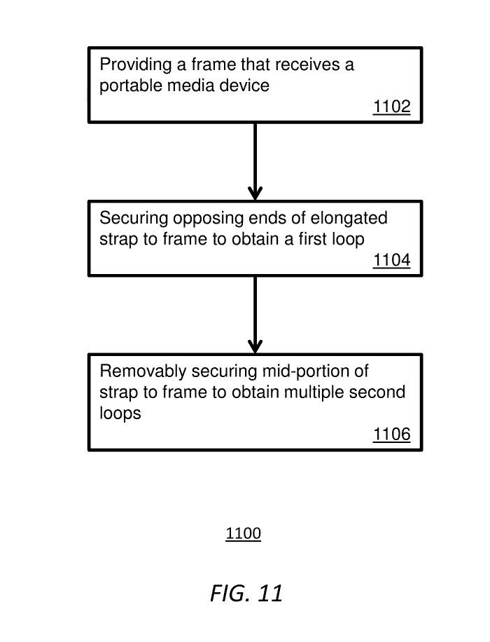

FIG. 10 depicts an illustrative embodiment of a supporting structure 1000 mounted to a suitcase 1054 according to a single-loop configuration 1043′. FIG. 11 depicts an illustrative embodiment of the supporting structure 1000 mounted to the suitcase 1054 according to a multi-loop configuration 1043″. It is understood that the various configurations and/or adjustments allow the assembly to be mounted to various devices in a manner that can be adjusted to a user's preferences to allow for optimal hands-free viewing. This includes single loop and/or multi loop configurations mounted to any suitable features of another structure, such as a seatback, including a headrest portion of a seat, a suitcase, or some other structure. Thus, a traveler can surf the web, watch multimedia, read books/magazines and so forth without having to hold the device for long periods of time. The benefits allow of optimal viewing positions to be established and maintained without a user having to maintain a grip on the tablet device. Other advantages include saving drops of a device, e.g., if the viewer becomes distracted, has to move suddenly and/or falls asleep.

In at least some embodiments, the sleeve can include one or more features to facilitate access to operational controls other than those available through a touchscreen. Such controls can include power buttons, volume settings, input/output ports for connecting to other devices, and so forth. Examples of such features can include openings along portion(s) of the sleeve including one or more of the backing and any pockets. The openings can be aligned with one or more operator controls and/or input-output ports.

FIG. 11 depicts a process 100 for securing a portable media device to another structure, such as a seat back, a cabinet, a stroller, a suitcase and the like. A frame is provided at 1102 that receives a portable media device. The frame can be rigid or flexible, such as the frames 104, 204, 304, 404 illustrated herein (FIGS. 1A-1D, 2, 3 and 4). Opposing ends of elongated strap are secured to the frame to obtain a first loop at 1104. In some embodiments, the first loop can be formed selectively along one or more sides of the frame. For example, the single loop can be formed along a long edge of a rectangular frame, referred to as a landscape configuration. Likewise, the single loop can be formed along a short edge of the frame, referred to as a portrait configuration. (See, e.g., the device 200′ of FIG. 2A).

The process further includes removably securing a mid-portion of the strap to the frame to obtain multiple second loops at 1106. The multiple loops can be used to grasp different portions or features of another structure on which the frame is mounted. The loops can be configured to maintain the portable media device in a level orientation. Alternatively or in addition, one or more of the loops or the strap itself can be configured to adjust a mounting height of the frame.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. For example, the rear surface 115 of the sleeve 104 is show as being solid. It is envisioned that in at least some embodiments, the rear surface can be partially and/or fully open. Thus, the sleeve 104 can be more of a frame structure upon which other features, such as the anchors 108, the loops 120, 122 and the pockets and/or retaining straps can be mounted. Other embodiments, include processes or methods for supporting a multimedia device according to the various techniques disclosed herein. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, can be used in the subject disclosure.

The Abstract of the Disclosure is provided with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A device, comprising:
a frame to receive a portable media device comprising a display surface, wherein the display surface of the portable media device, when received within the frame, is substantially unobstructed, wherein the frame comprises:
a plurality of strap anchors; and
a strap redirector positioned with respect to the plurality of strap anchors; and
an elongated strap comprising two opposing ends attached to the plurality of strap anchors,
wherein the strap redirector engages a portion of the elongated strap at a location between the two opposing ends, thereby forming a plurality of loops between the strap redirector and the two opposing ends, and
wherein the plurality of loops allow the frame to be suspended from a separate mounting structure, such that the display surface is positioned to allow hands-free viewing of media content displayed upon the portable media device.

2. The device of claim 1, wherein the frame further comprises a backing and a plurality of retaining elements attached to the backing, wherein the plurality of retaining elements removably secure the portable media device to the frame.

3. The device of claim 2, wherein at least retaining element of the plurality of retaining elements comprises an elastic material providing a retaining force to hold the portable media device against the frame when received within the frame.

4. The device of claim 2, wherein the elongated strap is adjustable to change a length of the elongated strap between a minimum length and a maximum length.

5. The device of claim 2, wherein the frame is formed from a flexible material configurable to a compact profile when separated from the portable media device.

6. The device of claim 5, wherein the flexible material comprises a fabric.

7. The device of claim 5, wherein the frame comprises a binding element that holds the frame in the compact profile during periods of non-use.

8. The device of claim 7, wherein the binding element comprises an elongated strap coupled at one end to the backing and free at another end, wherein the another end comprises a first fastener that engages a second fastener attached to the backing and positioned relative to the elongated strap, wherein the elongated strap holding the frame in the compact profile for periods of storage.

9. The device of claim 1, wherein the strap redirector comprises a loop attached to a rear surface of the backing, wherein a mid-portion of the elongated strap can be channeled through the loop forming a plurality of larger loops in the elongated strap extending between the loop and the plurality of strap anchors.

10. A device, comprising:
a collapsible supporting member comprising:
a frame;
a portable media device retainer attached to the frame;
a plurality of strap anchors attached to the frame; and
a strap redirector affixed relative to the frame and positioned between two strap anchors of the plurality of strap anchors; and
an elongated strap comprising two opposing ends attached to the plurality of strap anchors,
wherein the strap redirector engages a portion of the elongated strap at a location between the two opposing ends, thereby forming a plurality of loops between the strap redirector and the two opposing ends, and
wherein the plurality of loops allow the frame to be suspended from a separate mounting structure.

11. The device of claim 10, wherein a retaining element of the plurality of retaining elements comprises a pocket that receives a portion of the portable media device to the supporting member.

12. The device of claim 11, wherein a retaining element of the plurality of retaining elements comprises an elastic material that provides a retaining force to hold the portable media device against the frame when received within the frame.

13. The device of claim 11, further comprising a hanging fixture attached relative to the frame that engages a complementary fixture of another supporting structure to support hanging of the collapsible supporting member retaining the portable media device on the another supporting structure.

14. The device of claim 10, further comprising a binding element attached to the collapsible supporting member, wherein the binding element retains the collapsible supporting member in a collapsed configuration during periods of non-use.

15. The device of claim 10, wherein the frame comprises a backing that abuts a back surface of the portable media device.

16. The device of claim 10, wherein the strap redirector comprises one of a loop, a hook, a cleat, a spindle, a peg, a pin, or a combination thereof, attached to a rear surface of the backing.

17. A method comprising:
providing a frame that receives a portable media device comprising a display surface, wherein the display surface of the portable media device, when received within the frame, is substantially unobstructed;
securing opposing ends of an elongated strap to the frame to obtain a first loop suitable for mounting the frame to structure; and
removably securing to the frame a mid-portion of the elongated strap between the opposing ends, wherein the elongated strap, when secured to the frame at the mid-portion, results in a plurality of second loops suitable for mounting the frame to the structure.

18. The method of claim 17, further comprising redirecting the mid-portion of the first loop.

19. The method of claim 17, further comprising collapsing the frame to obtain a compact profile for storing the frame when not receiving the portable media device.

20. The method of claim 19, further comprising reversibly securing the frame in the compact profile.
